(19) United States
(12) Patent Application Publication
(10) Pub. No.: US 2026/0240713 A1
(43) Pub. Date: Aug. 20, 2026

(54) ELECTRIC MASSAGER AND ELECTRIC MASSAGER ASSEMBLY

(71) Applicant: XINRAN HEALTH TECHNOLOGY CO., LTD., SUZHOU (CN)

(72) Inventor: JIAN ZHANG, SUZHOU (CN)

(73) Assignee: XINRAN HEALTH TECHNOLOGY CO., LTD., SUZHOU (CN)

(21) Appl. No.: 19/637,255

(22) Filed: Apr. 2, 2026

Related U.S. Application Data
(63) Continuation of application No. PCT/CN2024/124649, filed on Oct. 14, 2024.

(30) Foreign Application Priority Data
Oct. 19, 2023 (CN) 202322802719.4
Oct. 19, 2023 (CN) 202322802720.7

(51) Int. Cl. A61H 7/00

(52) U.S. Cl. CPC A61H 7/008; A61H 7/005; A61H 2201/0153; A61H 2201/1215; A61H 2201/5071

(57) ABSTRACT

An electric massager and an electric massager assembly are disclosed. A massaging head is disposed at one end of a main body portion. A motor and a pressure sensor are disposed inside the main body portion. A side peripheral surface of the main body portion forms a pressure sensing zone. The pressure sensor is disposed against an inner surface of the pressure sensing zone to sense pressure applied to the pressure sensing zone. By applying pressure from a side of the main body portion, operation is convenient with high comfort. A controller adjusts a rotation speed of the motor according to the sensed pressure to adjust a massaging frequency of the massaging head. Massaging head frequency adjustment is more sensitive, while reducing the impact of pressure applied at the pressure sensing zone on massaging pressure, ensuring massaging comfort.

### TECHNICAL FIELD

The present disclosure belongs to the technical field of massagers, and specifically relates to an electric massager and an electric massager assembly.

### BACKGROUND

Existing electric massagers usually adopt a method of adjusting massaging intensity and frequency using gear buttons, where gears are sequentially switched according to a number of times the gear buttons are triggered. Since each person feels differently, in order to control gears more delicately, a large number of gears need to be set for the gear switching method. In the process of a user adjusting to a gear that is comfortable for the body, the user must switch one by one from low gears to high gears, which involves many operations and is very inconvenient. Some existing electric massagers adjust gears by providing multiple buttons that correspond to the gears one-to-one. Although this reduces the number of operations for gear switching, the setting of gear buttons affects the aesthetic appearance of the product.

There are also some electric massagers where a pressure sensor for sensing pressure is provided on a massaging head, and the intensity of the electric massager is adjusted by sensing the pressure applied by the massaging head to the skin. This adjustment method requires applying pressure to the skin surface, and the massaging intensity is related to the skin pressure, which affects the comfortable massaging experience.

Therefore, it is necessary to improve the prior art to overcome the defects in the prior art.

### SUMMARY

Therefore, what the present disclosure aims to solve is the technical problem in the prior art that massaging intensity adjustment is inconvenient and comfort is not high.

To solve the above technical problem, the present disclosure provides an electric massager, comprising:

a main body portion;

a massaging head, configured to massage skin, disposed at one end of the main body portion;

a motor, disposed in the main body portion, configured to drive the massaging head to perform a massaging movement;

a pressure sensor, disposed in the main body portion, configured to sense external pressure;

a controller, disposed at the main body portion and electrically connected to the motor;

wherein a side peripheral surface of the main body portion is formed with a pressure sensing zone, the pressure sensor is disposed against an inner surface of the pressure sensing zone to sense pressure applied to the pressure sensing zone, and the controller is electrically connected to the pressure sensor and is configured to control a rotation speed of the motor according to a pressure sensing signal of the pressure sensor to adjust a massaging frequency of the massaging head.

In one of the embodiments, a number of the pressure sensing zones includes two, the side peripheral surface of the main body portion includes two opposite side surfaces, and the two pressure sensing zones are respectively formed on the two opposite side surfaces.

In one of the embodiments, the main body portion has a median plane, a direction perpendicular to the median plane is a width direction of the main body portion, a width of the main body portion is smaller than a height and a length of the main body portion, and the pressure sensing zones are respectively disposed on the two opposite side surfaces along the width direction.

In one of the embodiments, projections of the two pressure sensing zones on the median plane are staggered from each other.

In one of the embodiments, the massaging head is disposed at one end of the main body portion in a height direction, the massaging head has a massaging port configured to fit against the skin, and an axis of the massaging port is parallel to the height direction of the main body portion.

In one of the embodiments, the pressure sensor is configured such that a pressure application direction of the sensed pressure is substantially perpendicular to the axis of the massaging port.

In one of the embodiments, the massaging head is a flexible structure, the massaging head is formed with a negative pressure cavity, an opening of the negative pressure cavity forms the massaging port, and the motor is connected to the massaging head to drive the massaging head to move reciprocatingly, so that a volume of the negative pressure cavity is changed to generate negative pressure at the massaging port.

In one of the embodiments, the electric massager further comprises a transmission connecting rod configured to convert a rotational movement of the motor into a reciprocating movement, and one end of the transmission connecting rod is connected to the motor and the other end is connected to the massaging head to drive the change in the volume of the negative pressure cavity.

In one of the embodiments, a number of the pressure sensors includes two, which are respectively disposed against the inner surfaces of the two pressure sensing zones, and the controller is configured to control the rotation speed of the motor according to a larger value of pressure sensing signals of the two pressure sensing zones.

In one of the embodiments, the electric massager further comprises a cover body configured to cover the massaging head, and the cover body is detachably connected to the main body portion.

In one of the embodiments, one of a magnet and a magnetic attraction member is fixedly disposed in the cover body, and the other of the magnet and the magnetic attraction member is disposed at a corresponding position of the main body portion, and when the cover body is closed on the main body, the magnet and the magnetic attraction member are attracted together.

In addition, the present disclosure further provides a pressure application operation accessory, used for pressure application to a pressure sensing zone of an electric massager, comprising:

a flexible sleeve, suitable for being sleeved on a main body portion of the electric massager, wherein the flexible sleeve includes a pressure-sensing cut-out region provided in a hollowed-out manner, and when the flexible sleeve is sleeved on the main body portion, the pressure sensing zone is exposed through the pressure-sensing cut-out region;

a trigger arm, disposed on an outer side of the flexible sleeve, wherein the trigger arm includes a connecting end and a trigger end opposite to the connecting end, the connecting end is connected to the flexible sleeve, the trigger end extends to an outer side of the pressure-sensing cut-out region, the trigger end includes an inner side surface facing the pressure-sensing cut-out region and an outer side surface opposite to the inner side surface, the outer side surface is configured for an operator to perform a pressing operation, and the inner side surface is configured to contact the pressure sensing zone to apply pressure;

wherein the trigger arm includes a deformed state after being pressed and a free state after pressure is released, and when the pressure is released, the trigger arm automatically returns to the free state.

In one of the embodiments, a hardness of the trigger arm is greater than a hardness of the flexible sleeve, and in the free state, a gap exists between the inner side surface of the trigger end and the pressure sensing zone.

In one of the embodiments, a connecting portion is disposed on the flexible sleeve, a positioning portion is disposed at the connecting end of the trigger arm, and the positioning portion is detachably connected to the connecting portion.

In one of the embodiments, the connecting portion is configured as a connecting post, an interior of the connecting post is hollow to form a plug-in hole, an outer contour of the positioning portion matches a shape of the plug-in hole, and the positioning portion is suitable for being inserted into the plug-in hole to position the trigger arm.

In one of the embodiments, a shape of an end surface of the connecting post matches a shape of a surface adjacent to a root of the positioning portion, and when the connecting end is connected to the flexible sleeve, the end surface of the connecting post fits with the surface adjacent to the root of the positioning portion.

In one of the embodiments, a number of the trigger arms is two, and the two trigger arms are oppositely disposed on two sides of the flexible sleeve.

In one of the embodiments, the connecting end of one of the trigger arms directly faces the trigger end of the other of the trigger arms.

In one of the embodiments, the inner side surface of the trigger end facing the pressure-sensing cut-out region is configured as a curved surface protruding toward a side of the pressure-sensing cut-out region.

In addition, the present disclosure further provides an electric massager assembly, comprising an electric massager and the pressure application operation accessory according to any one of the above embodiments.

The technical solutions provided by the present disclosure have the following advantages:

The electric massager and the electric massager assembly provided by the present disclosure have a massaging head disposed at one end of a main body portion, a pressure sensing zone formed on a side peripheral surface of the main body portion, and a pressure sensor disposed against an inner surface of the pressure sensing zone to sense pressure applied to the pressure sensing zone. With such a setting, an operator applies pressure from the side of the main body portion, resulting in convenient operation and high operating comfort; a controller adjusts a rotation speed of a motor according to the sensed pressure to adjust a massaging frequency of the massaging head, so that massaging head frequency adjustment is more sensitive, while the impact of pressure applied at the pressure sensing zone on the massaging pressure of the massaging head is reduced, ensuring massaging comfort.

The electric massager and the electric massager assembly provided by the present disclosure can be used as a sexual stimulation massager for performing various functions from medical treatment to sexual stimulation, especially for female sexual organ massage. The electric massager can apply pressure by being clamped between the legs. When the electric massager is clamped by the two legs, the inner sides of the legs contact two opposite pressure sensing zones. By clamping the two legs, pressure can be applied to the two pressure sensing zones, the pressure sensor can sense the applied pressure, and the controller is used to control the rotation speed of the motor according to the pressure sensing signal of the pressure sensor to adjust the massaging frequency of the massaging head, thereby adjusting the sexual stimulation intensity.

### BRIEF DESCRIPTION OF DRAWINGS

In order to more clearly illustrate the technical solutions in the embodiments of the present disclosure, the drawings required for use in the description of the embodiments will be briefly introduced below. Obviously, the drawings in the description below are merely some embodiments of the present disclosure, and for those of ordinary skill in the art, other drawings can also be obtained based on these drawings without creative labor.

FIG. 1 is a schematic perspective structural view of an electric massager provided by an embodiment of the present disclosure;

FIG. 2 is a schematic exploded structural view of the electric massager provided by the embodiment of the present disclosure;

FIG. 3 is a schematic exploded structural view of the electric massager shown in FIG. 2 from another perspective;

FIG. 4 is a schematic cross-sectional structural view of the electric massager provided by the embodiment of the present disclosure along a median plane;

FIG. 5 is a schematic perspective structural view of a cover body of the electric massager provided by the embodiment of the present disclosure;

FIG. 6 is a schematic perspective structural view of an electric massager using the pressure application operation accessory provided by the present embodiment;

FIG. 7 is a partial schematic exploded structural view of the electric massager using the pressure application operation accessory shown in FIG. 6 provided by the present embodiment;

FIG. 8 is a schematic perspective structural view of a flexible sleeve of the pressure application operation accessory provided by the embodiment of the utility model;

FIG. 9 is a schematic perspective structural view of a trigger arm of the pressure application operation accessory provided by the embodiment of the utility model.

### DETAILED DESCRIPTION OF THE EMBODIMENTS

The technical solutions of the present disclosure will be described clearly and completely below in conjunction with the accompanying drawings. Obviously, the described embodiments are part of the embodiments of the present disclosure, rather than all of the embodiments. The present disclosure will be described in detail below with reference to the accompanying drawings and in conjunction with embodiments. It should be noted that, in the case of no conflict, the embodiments and features in the embodiments of the present disclosure can be combined with each other.

It should be noted that terms such as "first" and "second" in the specification and claims of the present disclosure and in the above drawings are used to distinguish similar objects and are not necessarily used to describe a specific order or sequence.

In the present disclosure, unless otherwise stated, orientation terms such as "up, down, top, bottom" are usually with respect to directions shown in the drawings, or with respect to components themselves in a vertical, perpendicular, or gravity direction; similarly, for ease of understanding and description, "inner, outer" refers to inner and outer relative to the contour of each component itself, but the above orientation terms are not used to limit the present disclosure.

### Embodiment 1

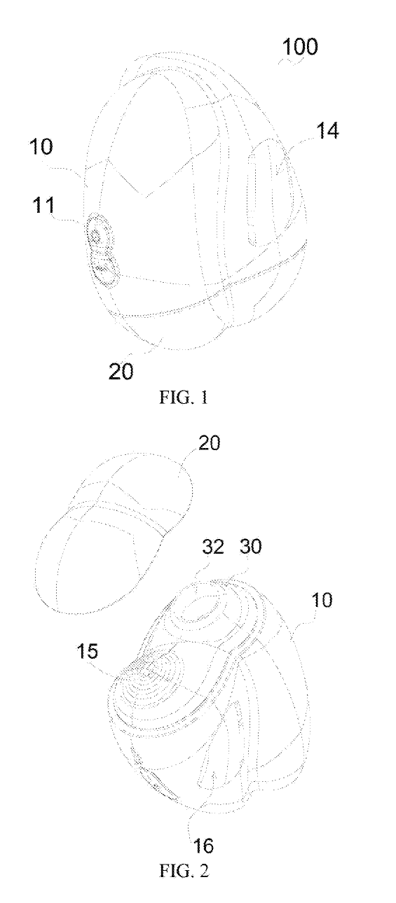

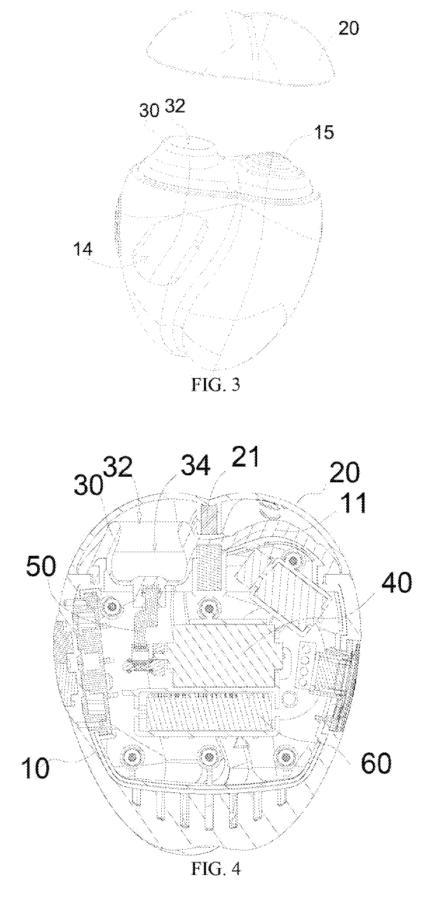

The present embodiment provides an electric massager 100, used for contacting a skin surface for massaging. FIG. 1 is a schematic perspective structural view of an electric massager provided by an embodiment of the present disclosure, FIG. 2 is a schematic exploded structural view of the electric massager shown in FIG. 1, FIG. 3 is a schematic exploded structural view of the electric massager shown in FIG. 2 from another perspective, and FIG. 4 is a schematic cross-sectional structural view of the electric massager provided by the embodiment of the present disclosure along a median plane. Please refer to FIGS. 1-4, the electric massager 100 comprises a main body portion 10, a massaging head 30, and a motor 40, a pressure sensor, and a controller 60 disposed in the main body portion 10.

The main body portion 10 is used for a user to operate to massage the skin, and is used for supporting and accommodating functional components. The functional components mainly include the motor 40, the pressure sensor (not shown), and the controller 60. An outer side surface of the main body portion 10 forms an operation area, and a user controls the main body portion 10 to contact the skin through the operation area. The pressure sensor is disposed against an inner side surface of the operation area to sense pressure applied to the operation area. The controller 60 is connected to both the pressure sensor and the motor 40, and is used to control a rotation speed of the motor 40 according to a pressure sensing signal of the pressure sensor to adjust a massaging frequency of the massaging head 30. A battery is also disposed inside the main body portion 10 for supplying power to the motor. Preferably, the battery is a rechargeable battery.

The operation area of the main body portion 10 is further provided with a control switch 11, and the control switch 11 is used to control starting and shutting down of the electric massager 100. Specifically, when the controller 60 receives a trigger signal from the control switch 11, it controls the motor 40 to start running. Preferably, the controller 60 controls a starting rotation speed of the motor 40 to be a minimum working rotation speed of the motor 40 according to the trigger signal of the control switch 11.

The massaging head 30 is used for contacting the skin to massage the skin, and is disposed at one end of the main body portion 10. For descriptive purposes, the end where the massaging head 30 is disposed is defined as a front end of the main body portion 10, and the opposite other end is a rear end. A direction from the "front end" to the "rear end" is a height direction of the main body portion 10, and the main body portion 10 has a center line parallel to the height direction. A side peripheral surface of the main body portion 10 surrounds the above center line, and the operation area is formed on the side peripheral surface.

Referring to FIGS. 2 and 3 in combination, the operation area of the main body portion 10 is formed with pressure sensing zones (14, 16), and the pressure sensor is disposed against an inner surface of the pressure sensing zones (14, 16) to sense pressure applied to the pressure sensing zones (14, 16). That is, the pressure sensing zones are formed by the side peripheral surface of the main body portion 10 and are located in the operation area to facilitate user operation. In the present embodiment, a number of the pressure sensing zones (14, 16) includes two, which are a first pressure sensing zone 14 and a second pressure sensing zone 16 respectively. The side peripheral surface of the main body portion 10 is annular and includes two opposite side surfaces. The first pressure sensing zone 14 and the second pressure sensing zone 16 are respectively formed on the two opposite side surfaces.

It should be noted that "two opposite side surfaces" refers to two surfaces with substantially the same shape and facing each other. Two pressure sensing zones formed on two opposite side surfaces is understood as the two side surfaces where the two pressure sensing zones are located being opposite, and is not understood as positions of the two pressure sensing zones being directly opposite.

In another embodiment, only one pressure sensing zone may be provided. Referring to FIGS. 1 and 2, only the first pressure sensing zone 14 may be provided, or only the second pressure sensing zone 16 may be provided. A single pressure sensing zone is used for sensing unilateral pressure application, and the controller 60 adjusts a motor rotation speed according to the unilateral pressure application to adjust the massaging frequency. In other embodiments, a number of pressure sensing zones can also be multiple, for example, 3 or 4, or more. A number of pressure sensing zones are arranged on the side peripheral surface of the main body portion 10, and a pressure sensor is correspondingly provided for each pressure sensing zone to sense pressure applied to the pressure sensing zone, and the controller adjusts the motor rotation speed according to operating pressures of the number of pressure sensors.

The electric massager provided in this embodiment is used for delicate skin massage. Exemplarily, the electric massager can be used for soothing massage of skin around the eyes and skin of the lower jaw, and can also be used for point massage of acupoints, such as soothing massage of temples. The electric massager can also be used for massage of other parts, which is not limited in this application. The electric massager of the present application is mainly for delicate skin massage, with weak vibration amplitude, and the vibration amplitude is within 5mm. Specifically, the vibration amplitude of the electric massager is 2mm-3mm.

In order to reduce an impact of vibration of the electric massager itself on the pressure application operation. In one embodiment, sensitivity of the pressure sensor is set to be less than a pressure change caused by its own vibration during its working process. Therefore, vibration of the electric massager basically does not lead to a change in a measured value of the pressure sensor, so that the electric massager can adjust the vibration frequency according to the pressure applied by the user. In another embodiment, the controller 60 is set to execute a control logic for adjusting the massaging frequency according to operating pressure only when a pressure change detected by the pressure sensor is higher than a preset floating threshold. That is, when a pressure change amplitude detected by the pressure sensor is smaller than the preset floating threshold, the controller 60 does not execute frequency adjustment control, and the massaging frequency of the electric massager remains unchanged. In this way, the change in the measured value of the pressure sensor caused by the vibration of the electric massager itself can be shielded through the preset floating threshold, thereby achieving the purpose of adjusting the massaging frequency according to the pressure applied by the operator.

In the electric massager provided by the present disclosure, the massaging head is disposed at one end of the main body portion, the pressure sensing zones are formed on the side peripheral surface of the main body portion, and the pressure sensor is disposed against the inner surface of the pressure sensing zones to sense pressure applied to the pressure sensing zones. A number of pressure sensing zones includes two, and the two pressure sensing zones are respectively formed on two opposite side surfaces of the main body portion. With such a setting, an operator applies pressure from two sides of the main body portion, resulting in convenient operation and high operating comfort; pressure can be sensed on both sides of the main body portion, so that the controller adjusts the rotation speed of the motor according to the sensed pressure to adjust the massaging frequency of the massaging head. Massaging head frequency adjustment is more sensitive, while the impact of pressure applied at the pressure sensing zone on the massaging pressure of the massaging head is reduced, ensuring massaging comfort.

The main body portion is substantially a symmetrical structure and has a median plane. FIG. 4 shows a cross-sectional view of the main body portion passing through the median plane. Referring to FIGS. 1 and 4 in combination, the median plane of the main body portion 10 is parallel to the height direction and substantially bisects the massaging head 30. According to the above definition of the height direction, the up and down direction of the paper in FIG. 4 is the height direction of the electric massager 100, the direction perpendicular to the median plane is the width direction of the main body portion 10, and the left and right direction of the paper shown in FIG. 4 is the length direction of the main body portion 10. In the present embodiment, the width of the main body portion 10 is smaller than the height and the length of the main body portion 10. The first pressure sensing zone 14 and the second pressure sensing zone 16 are respectively disposed on the two opposite side surfaces along the width direction. In this way, a thickness dimension of the main body portion between the two pressure sensing zones is minimal, making pressure application operation convenient.

In actual operation scenarios, positions of pressure application on opposite sides are often not directly opposite, while each pressure sensing zone is independent. In order to accurately match a relationship between an amount of pressure applied by an operator and the massaging frequency. In one embodiment, projections of the first pressure sensing zone 14 and the second pressure sensing zone 16 on the median plane are staggered from each other. That is, the two pressure sensing zones are not set directly opposite each other, and the pressure sensing zones sense pressure application amounts at corresponding positions on different sides, so as to accurately and sensitively capture an operator's intention to adjust the massaging frequency.

In specific embodiments, the massaging head 30 includes a massaging port 32 configured to fit against skin, and the massaging port 32 is used for fitting against skin to perform massaging movement. In actual use, an axis of the massaging port 32 is usually perpendicular to a skin contact surface. In this embodiment, the axis of the massaging port 32 is parallel to the height direction of the main body portion 10, which can facilitate an operator in controlling contact between the massaging port and the skin.

In order to suppress an impact of pressure sensed by the pressure sensing zones on contact pressure between the massaging port and the skin, so as to ensure a comfortable massaging experience. In specific embodiments, the pressure sensor is configured such that a pressure application direction of the sensed pressure is substantially perpendicular to the axis of the massaging port 32. A pressure component sensed by the pressure sensor and a pressure component of the massaging port on the skin do not affect each other, thereby facilitating user operation to control skin pressure and massaging frequency.

In specific embodiments, referring to FIGS. 3 and 4 in combination, the massaging head 30 is a flexible structure, the massaging head 30 is formed with a negative pressure cavity 34, an opening of the negative pressure cavity 34 forms the massaging port 32, and the motor 40 is connected to the massaging head 30 to drive the massaging head 30 to move reciprocatingly, so that a volume of the negative pressure cavity 34 is changed to generate negative pressure at the massaging port 32. Specifically, the electric massager 100 further comprises a transmission connecting rod 50. One end of the transmission connecting rod 50 is connected to an output shaft of the motor 40, and the other end is connected to the massaging head 30, converting rotational movement of the motor 40 into reciprocating deformation movement of the massaging head 30. During the reciprocating deformation movement, the volume of the negative pressure cavity 34 is frequently changed, thereby forming negative pressure at the massaging port 32, and the negative pressure is utilized to massage the skin surface.

In specific embodiments, a number of the pressure sensors includes two, which are a first pressure sensor and a second pressure sensor respectively, which are respectively disposed against inner surfaces of the first pressure sensing zone 14 and the second pressure sensing zone 16. The first pressure sensor is disposed against the first pressure sensing zone 14, and the second pressure sensor is disposed against the second pressure sensing zone 16. A pressure sensing signal of the first pressure sensor is a first pressure signal, a pressure sensing signal of the second pressure sensor is a second pressure signal, and the controller 60 is used for controlling the rotation speed of the motor 40 according to a larger value of the pressure sensing signals of the two pressure sensing zones. That is, if the first pressure signal is greater than the second pressure signal, the controller 60 controls the rotation speed of the motor 40 according to the first pressure signal; if the first pressure signal is smaller than the second pressure signal, the controller 60 controls the rotation speed of the motor 40 according to the second pressure signal. Wherein, a larger value of the pressure signal corresponds to a larger rotation speed of the motor 40. In this way, response sensitivity of the electric massager to pressure can be improved, and massaging experience can be enhanced.

In specific embodiments, the electric massager 100 further comprises a cover body 20 configured to cover the massaging head 30, and the cover body 20 is detachably connected to the main body portion 10. When needing to use the electric massager 100, a user removes the cover body 20 to expose the massaging head 30, so as to massage the skin. After use is completed, the cover body 20 is installed on the main body portion 10, and the massaging head 30 is covered and protected in the cover body 20, which can achieve dust prevention and protection.

Further, referring to FIG. 4 and 5 in combination, a magnet 21 is fixedly disposed in the cover body 20, and a magnetic attraction member 11 is disposed at a corresponding position of the main body portion 10. When the cover body 20 is closed on the main body portion 10, the magnet 21 and the magnetic attraction member 11 are attracted together to achieve reliable combination of the cover body 20 and the main body portion 10. Specifically, the magnetic attraction member 11 can be an iron block, or an alloy structure containing iron, nickel, or cobalt. Of course, the magnetic attraction member can also be disposed on the cover body 20, and correspondingly, the main body portion 10 is provided with a magnet, which is not limited here.

The main body portion 10 of the electric massager 100 is further provided with an auxiliary massaging head 15 configured to lean against the skin surface, which can utilize vibration of the main body portion 10 itself to massage the skin and can also assist in positioning the electric massager 100. Specifically, the auxiliary massaging head 15 is disposed at the same end as the massaging head 30 and is arranged side-by-side with the massaging head 30. The auxiliary massaging head 15 adopts a soft rubber material, and its overall shape is a cone with a rounded top.

In the electric massager provided by the present embodiment, pressure sensing zones are disposed on two opposite side surfaces of the main body portion, and the motor rotation speed can be adjusted by applying pressure on both sides to adjust the massaging frequency. Pressure adjustment is flexible and convenient, and massaging comfort is high.

### Embodiment 2

The present embodiment provides a pressure application operation accessory, used for being installed on a main body portion of an electric massager to assist in pressure application to a pressure sensor of the electric massager. The present embodiment takes a scene where the pressure application operation accessory is applied to the electric massager 100 shown in FIG. 1 for description, but it should not be understood as a limitation to the present disclosure.

In this implementation scenario, referring to FIGS. 1, 2, and 6 in combination, the electric massager 100 comprises a main body portion 10, and an outer side surface of the main body portion 10 is formed with pressure sensing zones. A pressure application operation accessory 80 is connected to the main body portion 20 for pressure application to the pressure sensing zones. Specifically, referring to FIG. 4, the main body portion 10 includes a massaging head 30 and a motor 40 drivingly connected to the massaging head 30, and the motor 40 is used to drive the massaging head to move so as to massage contacting skin.

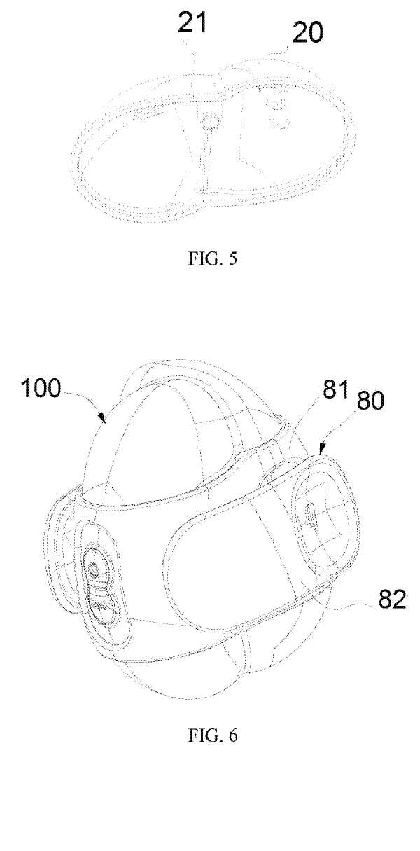

In the present embodiment, the pressure application operation accessory 80 is used for being installed on the main body portion 10 of the electric massager 100 to be used in cooperation with the main body portion 10. Of course, the electric massager 100 can also be used alone. When the electric massager 100 is used alone, as shown in FIG. 3, an operator can directly press and operate the pressure sensing zones (14, 16) to adjust the massaging frequency of the electric massager. When the pressure application operation accessory 80 is mated with the main body portion 10, as shown in FIG. 6, an operator applies pressure to the pressure sensing zones (14, 16) by operating the pressure application operation accessory 80. An operator can choose whether to adopt the pressure application operation accessory 80 according to specific operational comfort and personal preference.

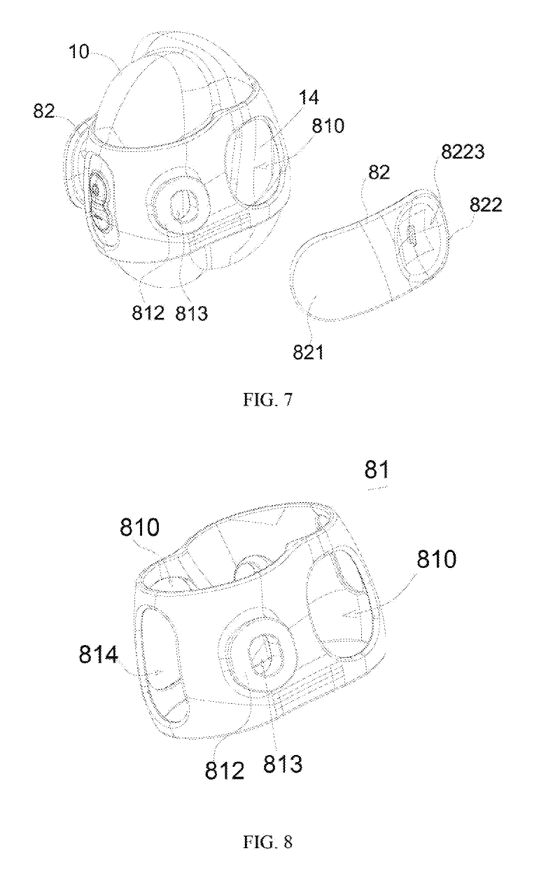

Referring to FIGS. 7 and 8, the pressure application operation accessory 80 comprises a flexible sleeve 81 and a trigger arm 82.

Wherein, the flexible sleeve 81 is a flexible structure suitable for being sleeved on the main body portion 10 of the electric massager. The flexible sleeve 81 includes a pressure-sensing cut-out region 810 provided in a hollowed-out manner. When the flexible sleeve 81 is sleeved on the main body portion 10, the pressure sensing zones (14, 16) of the main body portion 10 are exposed through the pressure-sensing cut-out region 810. Specifically, pressure-sensing cut-out regions 810 and pressure sensing zones are provided in a one-to-one correspondence. A number of the pressure-sensing cut-out regions 810 is two, and the first pressure sensing zone 14 and the second pressure sensing zone 16 respectively correspond to the two pressure-sensing cut-out regions 810. The flexible sleeve 81 is made of silicone material or flexible plastic.

It should be noted that the above-mentioned "hollowed-out manner" is understood as opening a notch in a specific middle area of a surface of the flexible sleeve, so as to facilitate direct exposure of an object located on the other side of the surface of the flexible sleeve. The pressure-sensing cut-out region 810 is a hollowed-out area provided corresponding to the pressure sensing zones (14, 16), used for exposing the pressure sensing zones (14, 16) of the main body portion 10. The flexible sleeve 81 can also be provided with hollowed-out areas for other purposes, and hollowed-out areas can be named correspondingly according to functions for which they are set.

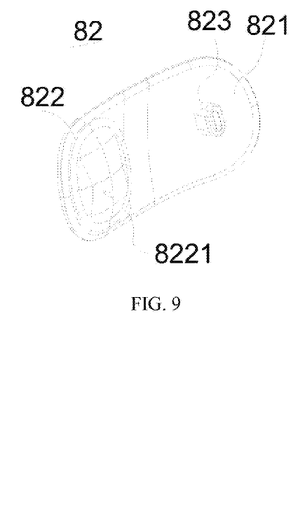

The trigger arm 82 is connected to the flexible sleeve 81 and is located on an outer side of the flexible sleeve 81 for pressure application to the pressure sensing zones (14, 16) of the electric massager 100. Specifically, referring to FIG. 7, the trigger arm 82 includes a connecting end 821 and a trigger end 822 opposite to the connecting end 821. The connecting end 821 is connected to the flexible sleeve 81, and the trigger end 822 extends to an outer side of the pressure-sensing cut-out region 810 for performing pressure application operation on the pressure sensing zones. Referring to FIGS. 7 and 9 in combination, the trigger end 822 includes an inner side surface 8221 facing the pressure-sensing cut-out region 810 and an outer side surface 8223 opposite to the inner side surface. The outer side surface 8223 is configured for an operator to perform a pressing operation, and the inner side surface 8221 is configured to contact the pressure sensing zones (14, 16) of the main body portion 10 to apply pressure. The trigger arm 82 is a structure capable of deforming and undergoes deformation under an external force. The trigger arm 82 includes a deformed state after being pressed and a free state after pressure is released. When pressure is released, the trigger arm 82 automatically returns to the free state. In this way, when an operator no longer applies pressure to the trigger arm 82, the trigger arm 82 automatically returns to the free state, and sensed pressure of the pressure sensing zones returns to an initial state. Usually, in the free state, a pressure application amount of the pressure sensing zones is zero.

In the present embodiment, the trigger arm 82 extends longitudinally, the connecting end 821 is located at one end in its length direction, and the trigger end 822 is located at the other end in the length direction of the trigger arm 82. When the trigger arm 82 is installed on the flexible sleeve 81 and the flexible sleeve 81 is sleeved on the main body portion 10, a position of the connecting end 821 relative to the main body portion 10 is fixed, and the trigger end 822 is cantilevered with the connecting end 821 as a pivot. When the trigger end 822 is pressed by an external force, the trigger end 822 undergoes deformation to generate a displacement relative to the pivot close to the pressure sensing zones (14, 16). This displacement amount is used to trigger the pressure sensing zones. That is, an operator applies pressure through the trigger end 822, and pressure is applied to the pressure sensing zones through the trigger end 822, rather than a pressure application method that directly triggers the pressure sensing zones.

The pressure application operation accessory provided by the present disclosure is used for pressure application to pressure sensing zones of an electric massager. A flexible sleeve is provided with a hollowed-out setting forming pressure-sensing cut-out regions corresponding to pressure sensing zones of a main body portion. One end of a trigger arm is connected to the flexible sleeve, and the other end serves as an operating end extending to an outer side of the pressure-sensing cut-out region for a user to operate to apply pressure to the pressure sensing zone through the operating end. The trigger arm increases an operating distance. In cases where directly triggering pressure sensing zone operation is inconvenient, a user can choose to use the pressure application operation accessory, thereby making pressure application operation in such cases convenient and improving usability of the electric massager.

Specifically, the hardness of the trigger arm 82 is greater than the hardness of the flexible sleeve 81. The hardness of the flexible sleeve 81 is smaller and it is also softer, making it easy to sleeve on the main body 10 of the electric massager. The trigger arm 82 adopts a harder material, which facilitates the trigger arm 82 automatically returning to the free state after the external force is released, improving durability of use of the trigger arm 82. In the free state, a gap exists between the inner side surface 8221 of the trigger end 822 and the pressure sensing zones (14, 16), thereby ensuring that when the trigger arm 82 is not operated, the pressure amount of the pressure sensing zones is zero. Preferably, the trigger arm 82 is made of plastic material. The flexible sleeve 81 is made of rubber.

In order to facilitate installation of the pressure application operation accessory on the main body portion. In specific embodiments, referring to FIGS. 8 and 9, a connecting portion 812 is disposed on the flexible sleeve 81, a positioning portion 823 is disposed at the connecting end 821 of the trigger arm 82, and the positioning portion 823 is detachably connected to the connecting portion 812. When the pressure application operation accessory needs to be installed, the flexible sleeve 81 can be sleeved on the main body portion 10 first. Since the shape of the flexible sleeve is soft and easy to deform, both sleeving and position adjustment are convenient. After the flexible sleeve 81 is installed, the trigger arm 82 is then installed on the connecting portion 812 of the flexible sleeve 81. The pressure application operation accessory is convenient to install.

Specifically, the connecting portion 812 is configured as a connecting post, an interior of the connecting post is hollow to form a plug-in hole 813, an outer contour of the positioning portion 823 matches a shape of the plug-in hole 813, and the positioning portion 823 is suitable for being inserted into the plug-in hole 813 to position the trigger arm 82. More specifically, the positioning portion 823 and the plug-in hole 813 are in interference fit. When the positioning portion 823 is inserted into the plug-in hole 813, the connecting portion 812 tightly surrounds and holds the positioning portion 823. The positioning portion 823 and the connecting portion 812 are connected in a non-rotatable manner, that is, the positioning portion 823 cannot rotate relative to the connecting portion 812, thereby positioning the trigger arm 82. Preferably, a cross-section of the connecting portion 812 is elliptical, and the plug-in hole 813 and the positioning portion also have similar elliptical shapes.

The trigger arm 82 is connected to the connecting portion 812 through the positioning portion 823. After the connecting portion 812 and the positioning portion 823 are connected, the connecting portion 812 will serve as a positioning pivot for the trigger arm 82. Pressure deformation and shape recovery of the trigger arm 82 are both supported by the positioning pivot. In order to improve reliability and stability of support for the trigger arm 82. A shape of an end surface of the connecting portion 812 matches a shape of a surface adjacent to a root of the positioning portion 823. When the connecting end 821 is connected to the flexible sleeve 81, the end surface of the connecting portion 812 fits with the surface adjacent to the root of the positioning portion 823. In this way, the end surface of the connecting portion plays a role in resisting and positioning the trigger arm, which can ensure reliable resetting of the trigger arm.

In specific implementation scenarios, referring to the contents of the first embodiment, a number of the pressure sensing zones (14, 16) is two, which are a first pressure sensing zone 14 and a second pressure sensing zone 16 respectively. The two pressure sensing zones are respectively disposed on two opposite side surfaces of the main body portion 20. Correspondingly, a number of trigger arms 82 is two, and the two trigger arms 82 are oppositely disposed on two sides of the flexible sleeve 81 for respectively triggering the two pressure sensing zones. Pressure sensors are disposed at the first pressure sensing zone 14 and the second pressure sensing zone 16 for detecting pressure applied to the first pressure sensing zone 14 and the second pressure sensing zone 16.

Specifically, the connecting end 821 of one trigger arm 82 directly faces the trigger end 822 of the other trigger arm 82. That is to say, trigger ends 822 of the two trigger arms 82 are not directly opposite each other, and connecting ends 821 of the two trigger arms 82 are also not directly opposite each other. In this way, when triggering force application, positions of force application are also not directly opposite, which can ensure sensing of force application at different positions on both sides and improve response sensitivity of the electric massager to pressure application.

In order to facilitate pressure application, in one embodiment, referring to FIGS. 7 and 9, the inner side surface 8221 of the trigger end 822 facing the pressure-sensing cut-out region 810 is configured as a curved surface protruding toward a side of the pressure-sensing cut-out region 810. Specifically, the curved surface is substantially circular, and a protruding height gradually increases from a periphery to a central region. When an external force applies pressure to the trigger end 822, the greater the applied pressure, the larger a contact area between the inner side surface 8221 and the pressure sensing zone; conversely, the smaller the applied pressure, the smaller the contact area between the inner side surface 8221 and the pressure sensing zone. The setting structure of the trigger end 822 can make triggering of the pressure sensing zone more uniform and stable, improving accuracy of pressure sensing.

In a specific embodiment, referring mainly to FIG. 8, the flexible sleeve 81 further includes button cut-out regions 814 configured to expose buttons of the main body portion. The button cut-out regions 814 include two, disposed on two opposite sides of the flexible sleeve 81. Specifically, the main body portion 10 includes a control switch 11, and the control switch 11 is exposed outside the flexible sleeve 81 through the button cut-out region 814 for starting and shutting down operations of the electric massager 100.

The pressure application operation accessory provided by the present embodiment provides a new operation method for the electric massager, which compensates for a fact that separate main body portion operation cannot meet operational needs of some operators, and improves versatility of the electric massager.

### Embodiment 3

The present disclosure further provides an electric massager assembly, comprising the electric massager 100 described in the above Embodiment 1 and the pressure application operation accessory 80 described in Embodiment 2. The above structures and components are all detailed in the sections for Embodiment 1 and Embodiment 2, and the same components adopt the same reference numerals and will not be described again here.

Obviously, the embodiments described above are only part of the embodiments of the present disclosure, rather than all of the embodiments. Based on the embodiments in the present disclosure, other various forms of changes or variations made by those of ordinary skill in the art without creative labor shall all fall within the scope of protection of the present disclosure.

What is claimed is:

1. An electric massager, characterized in that it comprises:
a main body portion;
a massaging head, configured to massage skin, disposed at one end of the main body portion;
a motor, disposed in the main body portion, configured to drive the massaging head to perform a massaging movement;
a pressure sensor, disposed in the main body portion, configured to sense external pressure; and
a controller, disposed at the main body portion and electrically connected to the motor;
wherein a side peripheral surface of the main body portion is formed with a pressure sensing zone, the pressure sensor is disposed against an inner surface of the pressure sensing zone to sense pressure applied to the pressure sensing zone, a number of the pressure sensing zones includes two, the side peripheral surface of the main body portion includes two opposite side surfaces, and the two pressure sensing zones are respectively formed on the two opposite side surfaces; and the controller is electrically connected to the pressure sensor and is configured to control a rotation speed of the motor according to a pressure sensing signal of the pressure sensor to adjust a massaging frequency of the massaging head.

2. The electric massager according to claim 1, characterized in that the main body portion has a median plane, a direction perpendicular to the median plane is a width direction of the main body portion, a width of the main body portion is smaller than a height and a length of the main body portion, and the pressure sensing zones are respectively disposed on the two opposite side surfaces along the width direction.

3. The electric massager according to claim 2, characterized in that projections of the two pressure sensing zones on the median plane are staggered from each other.

4. The electric massager according to claim 1, characterized in that the massaging head is disposed at one end of the main body portion in a height direction, the massaging head has a massaging port configured to fit against the skin, and an axis of the massaging port is parallel to the height direction of the main body portion.

5. The electric massager according to claim 4, characterized in that the pressure sensor is configured such that a pressure application direction of the sensed pressure is substantially perpendicular to the axis of the massaging port.

6. The electric massager according to claim 1, characterized in that the massaging head is a flexible structure, the massaging head is formed with a negative pressure cavity, an opening of the negative pressure cavity forms a massaging port, and the motor is connected to the massaging head to drive the massaging head to move reciprocatingly, so that a volume of the negative pressure cavity is changed to generate negative pressure at the massaging port.

7. The electric massager according to claim 6, characterized in that the electric massager further comprises a transmission connecting rod configured to convert a rotational movement of the motor into a reciprocating movement, and one end of the transmission connecting rod is connected to the motor and the other end is connected to the massaging head to drive the change in the volume of the negative pressure cavity.

8. The electric massager according to claim 1, characterized in that a number of the pressure sensors is two, which are respectively disposed against the inner surfaces of the two pressure sensing zones, and the controller is configured to control the rotation speed of the motor according to a larger value of pressure sensing signals of the two pressure sensing zones.

9. The electric massager according to claim 1, characterized in that the electric massager further comprises a cover body configured to cover the massaging head, and the cover body is detachably connected to the main body portion.

10. An electric massager assembly, characterized in that it comprises an electric massager and a pressure application operation accessory; wherein the electric massager comprises a main body portion and a pressure sensor disposed in the main body portion, a side peripheral surface of the main body portion is formed with a pressure sensing zone, and the pressure sensor is disposed against an inner surface of the pressure sensing zone to sense pressure applied to the pressure sensing zone;
the pressure application operation accessory is configured to auxiliary apply pressure to the pressure sensing zone of the electric massager, and the pressure application operation accessory comprises:
a flexible sleeve, detachably sleeved on the main body portion of the electric massager, wherein the flexible sleeve includes a pressure-sensing cut-out region provided in a hollowed-out manner, and when the flexible sleeve is sleeved on the main body portion, the pressure sensing zone is exposed through the pressure-sensing cut-out region; and
a trigger arm, disposed on an outer side of the flexible sleeve, wherein the trigger arm includes a connecting end and a trigger end opposite to the connecting end, the connecting end is connected to the flexible sleeve, the trigger end extends to an outer side of the pressure-sensing cut-out region, the trigger end includes an inner side surface facing the pressure-sensing cut-out region and an outer side surface opposite to the inner side surface, the outer side surface is configured for an operator to perform a pressing operation, and the inner side surface is configured to contact the pressure sensing zone to apply pressure;
wherein the trigger arm includes a deformed state after being pressed and a free state after pressure is released, and when the pressure is released, the trigger arm automatically returns to the free state.

11. The electric massager assembly according to claim 10, characterized in that a hardness of the trigger arm is greater than a hardness of the flexible sleeve, and in the free state, a gap exists between the inner side surface of the trigger end and the pressure sensing zone.

12. The electric massager assembly according to claim 10, characterized in that a connecting portion is disposed on the flexible sleeve, a positioning portion is disposed at the connecting end of the trigger arm, and the positioning portion is detachably connected to the connecting portion.

13. The electric massager assembly according to claim 12, characterized in that the connecting portion is configured as a connecting post, an interior of the connecting post is hollow to form a plug-in hole, an outer contour of the positioning portion matches a shape of the plug-in hole, and the positioning portion is suitable for being inserted into the plug-in hole to position the trigger arm.

14. The electric massager assembly according to claim 13, characterized in that a shape of an end surface of the connecting post matches a shape of a surface adjacent to a root of the positioning portion, and when the connecting end is connected to the flexible sleeve, the end surface of the connecting post fits with the surface adjacent to the root of the positioning portion.

15. The electric massager assembly according to claim 10, characterized in that a number of the pressure sensing zones includes two, the side peripheral surface of the main body portion includes two opposite side surfaces, the two pressure sensing zones are respectively formed on the two opposite side surfaces, a number of the trigger arms is two, the two trigger arms are oppositely disposed on two sides of the flexible sleeve, and the two trigger arms and the two pressure sensing zones are disposed in a one-to-one correspondence.

16. The electric massager assembly according to claim 15, characterized in that the connecting end of one of the trigger arms directly faces the trigger end of the other of the trigger arms.

17. The electric massager assembly according to claim 10, characterized in that the inner side surface of the trigger end facing the pressure-sensing cut-out region is configured as a curved surface protruding toward a side of the pressure-sensing cut-out region.
